(19) United States
(12) Patent Application Publication
(10) Pub. No.: US 2018/0075156 A1
(43) Pub. Date: Mar. 15, 2018

(54) PRODUCT AND METHOD FOR PROVIDING INFORMATION IN A SYSTEMATIC MANNER THAT IS EASILY ACCESSIBLE

(71) Applicant: James B. Broselow, Hickory, NC (US)

(72) Inventor: James B. Broselow, Hickory, NC (US)

(21) Appl. No.: 15/801,491

(22) Filed: Nov. 2, 2017

Related U.S. Application Data
(63) Continuation-in-part of application No. 15/602,476, filed on May 23, 2017.
(60) Provisional application No. 62/394,384, filed on Sep. 14, 2016.

(51) Int. Cl. G06F 17/30; G06K 19/06; G06K 7/10

(52) U.S. Cl. CPC G06F 17/30879; G06K 19/06046; G06K 2007/10524; G06K 7/10861; G06F 17/30887; G06K 19/06037

(57) ABSTRACT

A product and method for providing information in a manner that is easily accessible when necessary or desirable. In one embodiment of the invention, information is uploaded to a server and a label, sticker or other surface is provided with at least first and second bar codes, one of which is used to access an instructional message, such as a video, and the other of which allows a user to utilize the instruction received from access to the first bar code to permit a task to be performed. Several examples of these uses are described in this application.

### CROSS-REFERENCE TO RELATED APPLICATION AND PRIORITY

This application is a continuation-in-part of U.S. patent application Ser. No. 15/602,476, filed May 23, 2017, which claims priority from U.S. Provisional Patent Application No. 62/394,384, filed Sep. 14, 2016, the contents of which are incorporated by reference herein.

### TECHNICAL FIELD AND BACKGROUND OF THE INVENTION

This invention relates to a product and method for providing information in a manner that is easily accessible when necessary or desirable. In one embodiment of the invention, information is uploaded to a server and a label, sticker or other surface is provided with at least first and second bar codes, one of which is used to access an instructional message, such as a video, and the other of which allows a user to utilize the instruction received from access to the first bar code to permit a task to be performed. Several examples of these uses are described in this application.

The establishment of the Internet along with unprecedented ability to store information has revolutionized the basic concept of a “reference.” Internet access is available as a matter of course in virtually every public and most private areas. Data storage has become very inexpensive and is thus, a commodity affordable to every business and to most individuals. Numerous methods of storing and accessing data have been developed and many more will be developed in the future.

From books to electronic encyclopedias, simple text to multimedia, PCs to mobile computers—the capacity to store and access vast amounts of information is becoming increasingly commonplace and available to more and more businesses and individuals. Yet, the abundance of resources and the very inexpensive means of storing and retrieving digital data can create its own barriers.

How does an individual find exactly the needed or desired information without regard to language, education or technology skills? The expectations and business practices of enterprises that profit from the use of digital information in its varying forms often proceed ahead of the ability of many members of society and other businesses to fully use the information in a meaningful manner.

The ability to find information in almost any language, to have the information displayed as words, text to speech, pictures, graphics, animations or videos in many ways can eliminate or ease the limitations of most humans seeking to learn and understand. The limitations can then be viewed as not so much how to customize the knowledge for almost any situation, but rather how to access the exact knowledge that is needed at any time, or place, or circumstance. A “search engine”, such as Google, requires, both time and effort and a fundamental knowledge of how it works in order to search and continuously narrow the choices until the desired information is located. It is commonly the case that an internet search often returns millions of “hits”, which may be displayed according to whether or not the content provider is a paying sponsor, rather than based on relevancy. In emergency situations, the requirement to scroll through a large number of displayed links in search of a specific need can be problematic.

In computerized systems, medical computer systems being a good example, “contextual searches” have been developed to narrow the search focus. For example, if an electronic system already knows that a patient has a diagnosis of diabetes, the search engine looking for general medical information will filter for diabetes. However, in the physical world, context can be infinitely broad and can encompass any situation from being stuck in an elevator to needing to perform effective CPR in an emergency situation.

Alternatively, perhaps a particular instruction or repair manual is needed for an obsolete machine, appliance or other device, or a worker needs to know exactly how wiring in a particular house should be installed. The challenge, then, is how to store and then find the relevant information within the context of everyday life.

Many websites contain vast collections of repair and instruction manuals, software updates, patches and supplements, often identified only by reference to model or serial numbers or other information that may be no longer available. Sifting through this amount of information can be taxing even for knowledgeable internet and computer users and simply beyond the capabilities of many individuals. It is an uncomfortable reality that much information on the internet is obsolete since there is no established protocol for removing or updating such information.

A large step towards solving this basic need would be to provide the capability to find or create the specific information needed, electronically “tag” that information, for example, by using a bar code aimed at the relevant digital address, provide a bar code such as a QR code containing that URL, print that URL onto a “sticker” and then apply the sticker to a “thing” or “place” where that information may later be needed. At any subsequent time, the QR code can be scanned, the relevant digital address accessed via an intranet or internet address and the electronically tagged information downloaded onto a digital device, such as a smart phone, pad or other device. Stickers maybe used in a variety of ways that facilitate use by individuals without significant computer or internet use skills, as described below.

### SUMMARY OF THE INVENTION

It is therefore an object of the present invention to provide a means by which specific information can be provided and associated with a specific location, object or function.

It is another object of the invention to provide a means by which specific information can be provided and retrieved using any one of a number of digital devices when and where needed to the exclusion of other unnecessary information.

It is another object of the invention to facilitate use of the internet to convey or retrieve specific information by individuals without significant computer or internet use skills.

It is another object of the invention to facilitate use of the internet to update information that can then be accessed and utilized by a user retrieving the information using the same bar code.

It is another object of the invention to provide on a surface at least first and second bar codes, one of which is used to access an instructional message, such as a video, and the other of which allows a user to utilize the instruction received from access to the first bar code to permit a task to be performed.

It is another object of the invention to provide a method by which multiple users can communicate sequentially and in conference via the internet in audio and/or video modes using bar codes and universally available digital devices.

These and other objects and advantages of the invention are achieved by providing an article of manufacture and method by which information is uploaded to or accessed on a server. A digitally readable physical display object such as a label, tag or sticker is provided that contains coded symbols, such as a bar code, that represent a combination of a URL and a unique passcode. Access to that particular information is accessed, for example, by scanning the sticker with an internet-connected device, such as a bar code scanner or a mobile phone equipped with an application that allows various types of bar codes to be read. Scanning the sticker, accesses the server via the URL. Information associated with the URL is downloaded and is accessible via the scanner, mobile phone or other digital scanner device capable of accessing the server via the URL.

According to one embodiment of the invention, a method provides ready access to information, and comprises the steps of preparing an object with a surface having first and second distinct bar codes, and preparing content in first and second segments associated with the respective first and second bar codes having a predetermined interrelationship. The content is associated with the first and second bar codes and is loaded onto an internet server. The first bar code on the object is scanned with a digital scanner device. The content is accessed and utilized. The second bar code on the object is scanned with a digital scanner device and the content is accessed and utilized.

According to another embodiment of the invention, the method includes the steps of updating/altering the content on the server associated with at least one of the first and second bar codes and scanning the updated/altered content on the server with the digital scanner device.

According to another embodiment of the invention, the method includes updating/altering the content on the server associated with both the first and second bar codes.

According to another embodiment of the invention, the step of preparing the object comprises creating a sticker or label.

According to another embodiment of the invention, the scannable digital code is a QR code.

According to another embodiment of the invention, the scannable digital code is an image of a physical object.

According to another embodiment of the invention, the method includes the step of creating a discrete passcode for being associated with a predetermined address of the server.

According to another embodiment of the invention, the method includes the step of deleting the selected information from the server after it is downloaded.

According to another embodiment of the invention, a product is provided for permitting access to digital content stored on a server that includes an object having a surface on which is placed a first bar code and a second bar code, the first and second bar codes having distinct URLs for accessing distinct content on the sever that is interrelated with the first and second bar codes.

According to another embodiment of the invention, the bar code is a QR code.

According to another embodiment of the invention, the content is selected from the group consisting of audio content, video content, audio/video content, text and still images.

According to another embodiment of the invention, the first bar code contains content that provides a learning experience to the viewer and the second bar code provides content enabling the user to utilize the content learned by accessing the content associated with the first bar code.

According to another embodiment of the invention, a method is provided by which multiple users can communicate sequentially and in conference via the internet in audio and/or video modes using bar codes and universally available digital devices.

### BRIEF DESCRIPTION OF THE DRAWING FIGURES

The present invention is best understood when the following detailed description of the invention is read with reference to the accompanying drawings, in which:

FIG. 1 is a flow diagram illustrating one preferred method of carrying out the invention;

FIG. 2 is a perspective view of a sticker having first and second bar codes providing access to different URLs;

FIG. 3 is a view showing a digital scanner device accessing the first bar code;

FIG. 4 is a view showing interconnection between the digital scanner device and the internet whereby content is accessed and transmitted from the internet to the digital scanner device user as a means of learning information;

FIG. 5 is a view showing a digital scanner device accessing the second bar code;

FIG. 6 is a view showing interconnection between the digital scanner device and the internet whereby content is transmitted from the internet to the digital scanner device user as a means of utilizing the information accessed by the first bar code; and

FIGS. 7-11, inclusive, are diagrammatic explanations of how an application for carrying out the invention can be configured and function.

### DETAILED DESCRIPTION OF THE PREFERRED EMBODIMENT

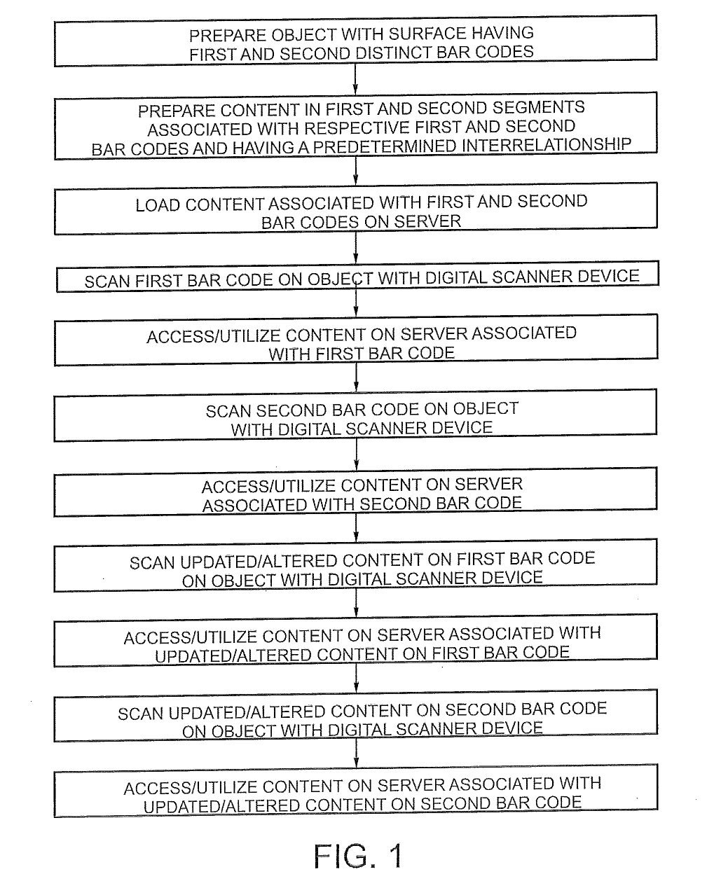

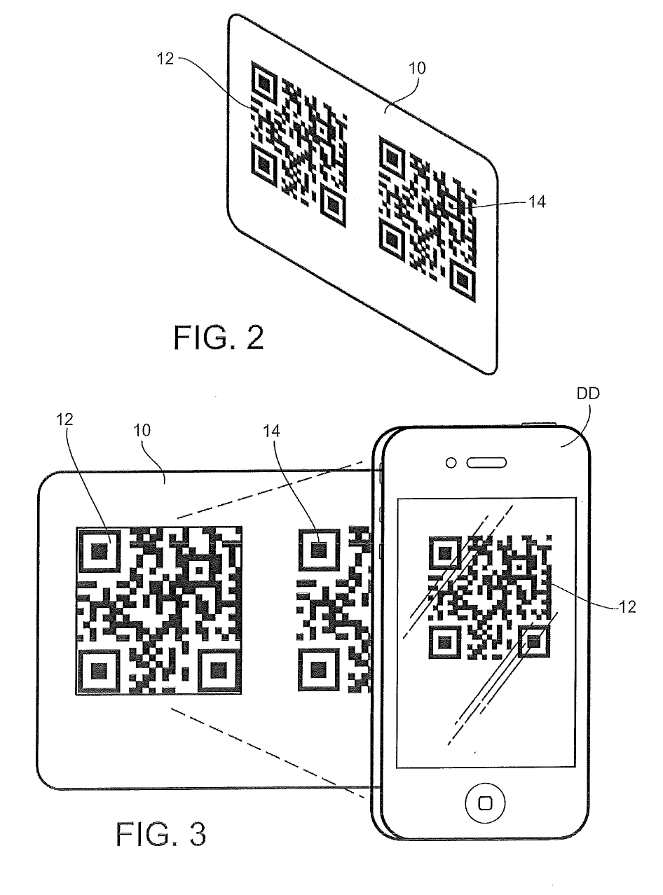

Referring now to FIG. 1, a method of the article of manufacture 10 shown in FIGS. 2, 3 and 5 is shown in flow chart form. In its most basic form, two bar codes are placed on a surface in proximity to each other, providing access to distinct URLs. The surface can be on a sticker, label, tag, wall, appliance panel or any other relatively planar surface on which a bar code such as a QR code can be placed. As used in this application, the term “bar code” is intended to be expansive and includes images in various current forms, such as QR codes, as well as, future images not yet developed. One anticipated usage involves “image recognition” whereby the image of a face, appliance, machine or any other object can serve as a means by which the digital scanner device recognizes the image and associates the image with a URL.

In one embodiment, a surface is prepared by placing on it first and second distinct bar codes. The bar codes provide access via the internet to two segments of content contained in a server, associated with the bar codes and having a predetermined interrelationship. For example, the content accessed by the first bar code may be video instructions on how to perform cardiopulmonary resuscitation (“CPR”) on an individual in one segment, and the content accessed by the second bar code a set of “use” instructions or guides to use during a resuscitation event. In such an instance, the “use” instructions can be an audio recording of the pace at which compression of the sternum should occur to maximize the beneficial effect of the procedure.

A significant advantage is the ability of an owner of “editing rights” to change the content at any time without the need to change the bar codes. For example, the American Heart Association has recently changed its recommendations for CPR by eliminating the “mouth-to-mouth” component of the procedure and instead instructing that the sternum be vigorously compressed at a rate of 100 compressions per minute. A change such as this can be easily distributed for training or use purposes by loading the new content with the same URL onto a server. Later, scanning the first bar code can provide a video instruction of the new procedure. Scanning the second bar code can provide verbal instructions together with an actual audio timing beat of 100 compressions per minute.

In another example, a machine manufacturer places a sticker, label, etc. with two distinct bar codes on each machine. Accessing the first bar code provides the user with an up-to-date parts manual, users' manual or any other desired information. Accessing the second bar code, provides video and/or audio instructions on ordering parts, using the machine, etc. The machine manufacturer can update the material on the server associated with two bar codes at will, keeping the material up-to-date for its customers without the need to send out updated material by mail or even by the internet.

In general, the article and method provide a unitary way of “learning” and then “doing.” The learning content of the first bar code has comprehensive, educational content, whereas the second bar code, which accesses the “doing” content, is a brief summary together with related audio or video content that can be used at the time of actual need.

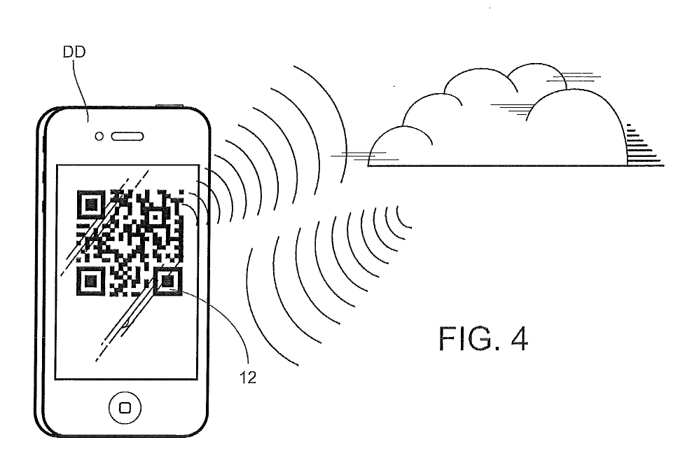

Referring now to FIG. 2, a preferred embodiment of the article used with the method according to the invention is shown. In a broad sense, a physical object is provided with a means of being digitally read. This can be any form of scannable bar code, QR code or other digitally readable article such as a sticker, label or an image applied directly to a surface. As shown by way of example, a sticker 10 is provided with two QR codes 12 and 14, which are distinct from each other in the sense that they direct the digital scanner device that has scanned the bar code to different although related URLs. This content may be text, images, audio or audiovisual material contained on a digital storage device that is capable of uploading that content to the server, for example, a smart phone, pad or the similar digital scanner device “DD” such as the smart phone shown in FIGS. 3-6. While in specific instances logon information may be required, in many if not most instances, the information will be intended to be readily available without the need for login information, such as user name and passcode.

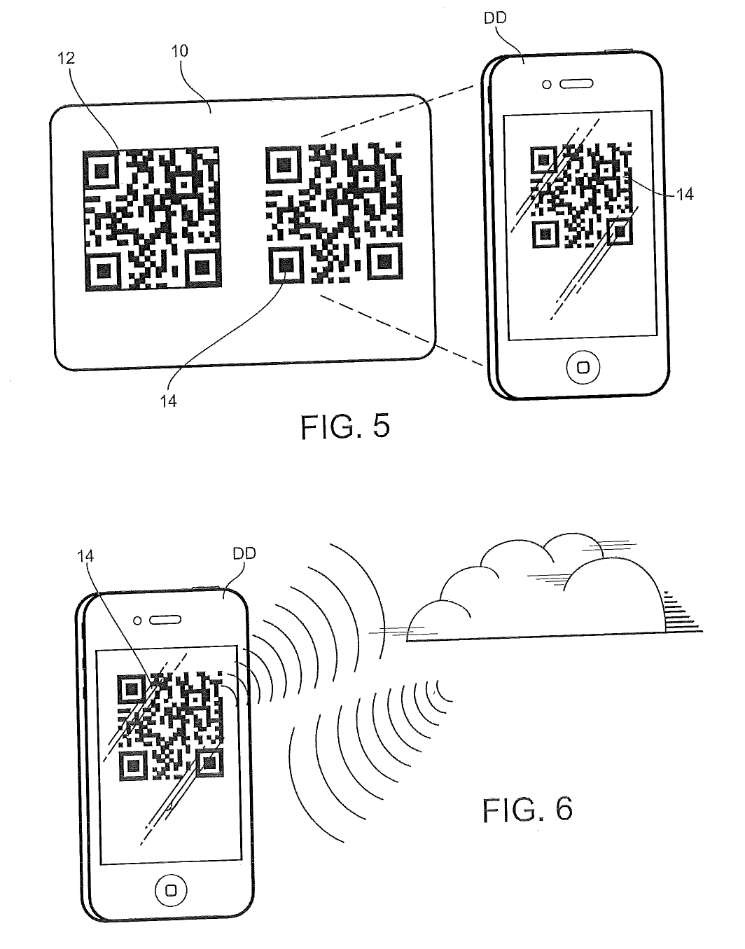

As shown in FIG. 3, bar code 12, the “learning” bar code 12 is scanned first. The digital scanner device DD transmits a wireless signal containing the URL imbedded in the bar code 12 through the internet system to a server where the desired information is stored, i.e., the “cloud” in FIG. 4. The server responds by transmitting the information back to the digital scanner device DD in a manner ready for use, such as text, audio, video, or a combination of these formats. As noted above by way of example, the information may be audio/video instructions on how to carry out CPR on a patient. If, later, an actual need for CPR arises, the second QR code 14 is scanned and the information is downloaded from the server in the same manner. See FIGS. 5 and 6. In this example, the downloaded information may be a voice, tone or other audio output from the digital scanner device that provides an audible timing beat that can be used by the person administering CPR to compress the sternum at the appropriate rate.

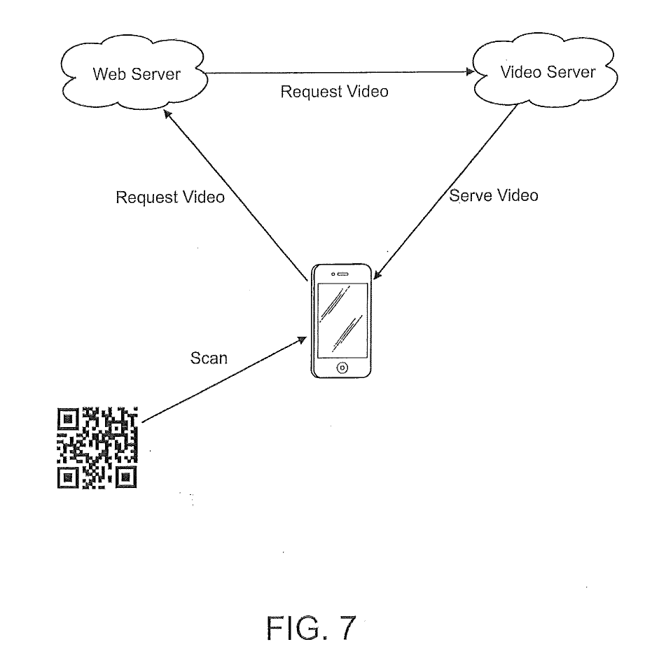

Referring now to FIG. 7, the “learn and do” function is further explained. A user scans a QR code using a digital device, such as a phone. The phone decodes the QR code and sends the URL to a web server, which sends the URL to a video server. The phone, when prompted, plays back the video file to the user.

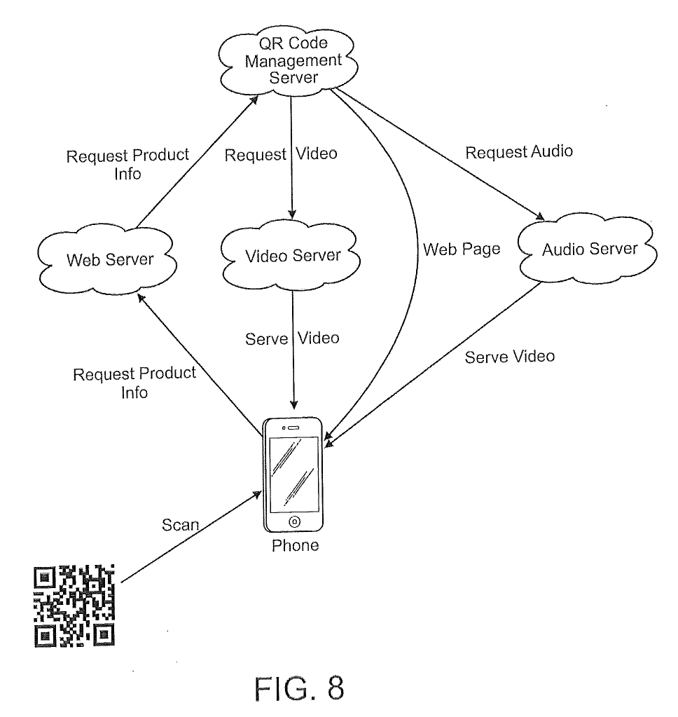

As shown in FIG. 8, a user scans a QR code using a digital device, such as a phone. The phone decodes the QR code and sends the URL to a web server, which sends the URL to a QR code management server. The QR code management server sends a request to an audio server. The audio server serves the audio file to the phone and the phone plays the audio file for the user.

If the request is for a video file, the QR code management server sends a request to the video server and the video server serves the video file to the phone. The phone plays back the video file for the user.

If the request is for a web page, the QR code management server delivers the web page to the phone, and the phone displays the web page by means of a phone-resident browser.

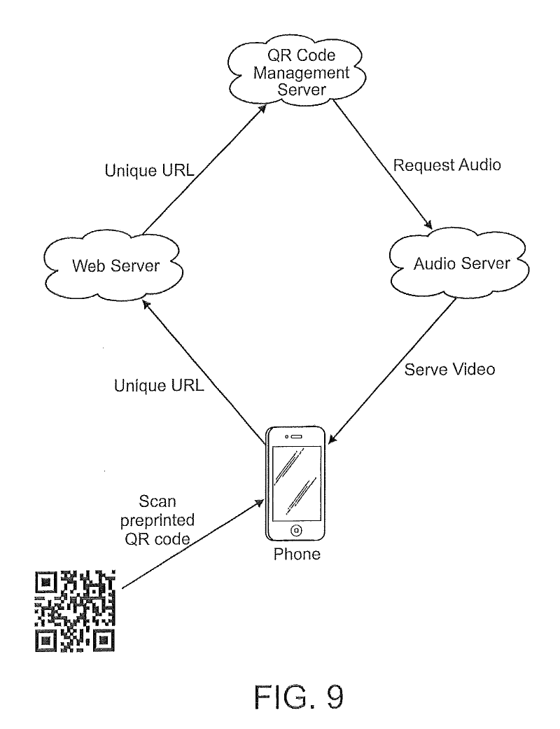

Referring to FIG. 9, to access and play an audio file, the user scans a QR code with a digital device such as a phone. The phone decodes the QR code and sends the URL to a web server, which sends the URL to a QR code management server, which forwards the request to an audio server. The audio server delivers the audio file to the phone and plays the audio file to the user when prompted to do so.

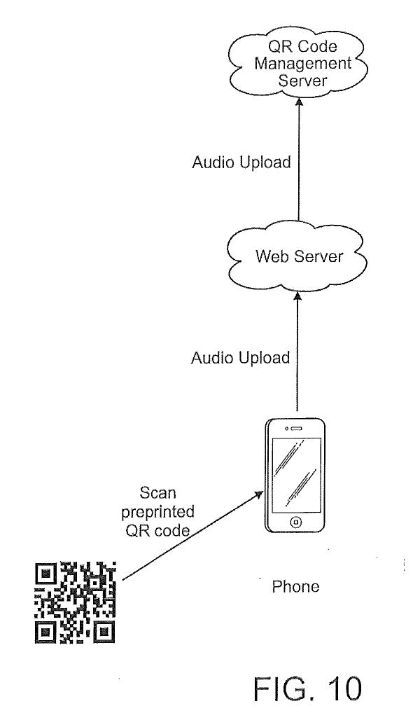

As shown in FIG. 10, to record an audio message, the user scans a preprinted QR code with a digital device such as a phone, when prompted, the user records an audio message. The phone decodes the QR code and sends the resultant URL and the recorded audio file to a web server. The web server sends the URL and audio file to the QR code management server, and the QR code management server stores the URL and audio file for subsequent use.

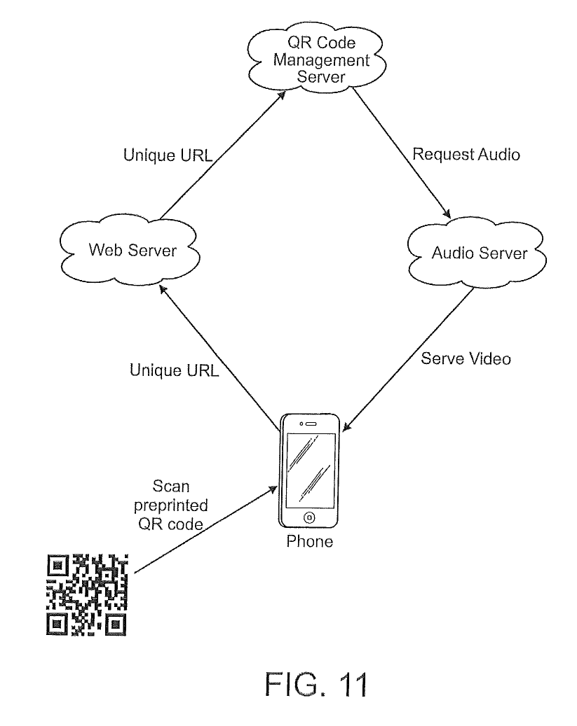

FIG. 11 illustrates a specific use of the audio feature to download instructions for use of, for example, emergency equipment such as a fire extinguisher, CPR device, fuel shut-off devices or the like. The user scans a QR code, which may be applied to the device to be used or nearby. The phone decodes the QR code and sends the URL to the web server. The QR code management server sends a request to the audio server, which serves the audio file to the phone, which plays the audio file for the user. The same technique can be used to provide video and both audio and video instructions.

By way of further specific illustration, assume that a parent wishes to provide dinner and homework instructions to a child when the child arrives at home. The parent either prepares a message by means of an audio recording or text message, accesses the server, uploads the recording or message and then places the sticker on the refrigerator. The child can later access the message by scanning the sticker. The QR code connects to the website and downloads the recording or message for the child, who is informed that lunch, dinner or a snack is in the refrigerator and that the homework has to be finished by a certain time. The first QR code 12 can provide the above information, whereas the second QR code 14 can provide an illustrated example of how to warm the food items in the microwave.

If the content is intended for only a single download, the system can be programmed to automatically delete the message.

The range of uses is limited only by the ability to upload and then download specified content as illustrated in the further examples set out below.

As another example, an electrician, cable installer or other provider arrives at a new location and needs to know the location and type of electrical, Internet or TV wiring in the house. A “sticker” has previously been applied to, for example, a TV box or remote control, which the service provider can access with a smart phone to obtain the needed information. If the wiring is modified during that visit, the information can then be updated for future reference by updating the information or providing a new sticker to take the place of the obsolete one. The downloaded information can also reference previous problems, repair instructions, parts numbers and where inventoried any other useful information. The QR codes 12 and 14 can be used in various manners to store the above information for sequential or other use.

As another example, a sticker can be provided with a QR code that includes a URL to a website that contains medical information concerning a specific patient. This information may include current and past medical conditions, prescriptions and drug interactions, vital statistics, contact information and similar other information. The sticker can be placed next to a patient bed, on a chart or in any other suitable location.

QR code stickers can be applied both to “things” and also, to sections of books that duplicate specific multimedia information, for example, a recipe book with the names of favorite recipes, each containing a sticker that shows not only the ingredients but also perhaps a video showing how to prepare the item. In this context, the term “sticker” refers to a specific printed area of page, and not necessarily to a physical object that is adhered to the book page.

Coded stickers on family heirlooms can relate the stories associated with them, antiques that show the value for family or insurance purposes—the possibilities are almost endless when some person, somewhere, might want to retrieve exact information, virtually in seconds, simply by scanning a sticker into a cell phone.

A QR code sticker maybe provided for use when a person is suddenly required to do CPR. The sticker 10 is placed on the wall of a hospital room or on a defibrillator and a video of the CPR technique is immediately seen and heard as a guide to the proper rate and technique of hands-only CPR. The Automated External Defibrillation (“AED”) itself has a video showing exact instructions regardless of the language capabilities of the responder at hand.

Other numerous uses are possible. For example, audio messages recorded and downloaded that contain living will directives, or a message from a deceased loved one adhered to the back of a photograph. In such instances, the QR codes 12 and 14 maybe used to contain, for example, messages to two individuals or groups of individuals. The QR codes 12 and 14 may be used to sequence specific learning and performance needs, such as the CPR administration referred to above or teaching and prompting the correct use of a fire extinguisher, teaching and then prompting the practicing of a musical score, and the like.

Use in an educational environment can include a method whereby for each day's lesson a classroom teacher uploads new multimedia to a single, editable, URL that can be accessed by each student in the class via a bar code such as a QR code that is attached to each student's desk. Scanning the bar code displays the desired educational content on the student's digital device. A copy of the bar code can be mounted on a notebook, textbook or on a work location at home for use during homework assignments. According to a further iteration, differing bar codes can be assigned to a student based on that student's development level, and reassigned based on the student's further progress. Parents can also access the student's assignments and study material using their own digital device.

By assigning two or more people the same bar code, they can have voice and/or video communication over the internet without needing regular phone service, for example, on an airplane or in a foreign country. This takes place by a person scanning the bar code with a digital device, which displays a digital recording application. A recording is made that is transmitted to the server associated with the bar code. At the same time, an email or text message can be sent to one or more recipients that a recorded message has been transmitted for receipt. The designated recipient(s) scan a bar code linked to the same server, and the digital recording application opens. The recipient(s) open and listen to the recording and view any associated video. The recording may be erased or recorded over. Alternatively, a series of two-way communications can be documented and preserved by the application in a mode where each new recording is linked to the previous recording(s) and stored until such time as the recipient(s) determine that the preservation is no longer necessary. The application can provide that either participant delete the recordings, or that each recipient must consent to the deletion.

If a desired recipient does not have initial access to the necessary bar code, the bar code can be emailed or texted to the recipient along with the message. In the manner described above, the audio and/or video communication can be one-way or two-way. The system is inherently secure since only those digital device users who can access the required bar code can access the communication. The application software can also be programmed to delete the recordings after an initial access event, or after a certain amount of time has elapsed.

Each of the descriptions of use above is carried out based essentially on the principles shown and described in the Figures.

A product and method for providing information in a manner that is easily accessible when necessary or desirable. Various details of the invention maybe changed without departing from the scope of the invention. Furthermore, the foregoing description of the preferred embodiments of the invention and best mode for practicing the invention are provided for the purpose of illustration only and not for the purpose of limitation, the invention being defined by the claims.

I claim:

1. A method for providing ready access to information, comprising the steps of:
(a) preparing an object with a surface having first and second distinct bar codes;
(b) preparing content in first and second segments associated with the respective first and second bar codes having a predetermined interrelationship;
(c) loading the content associated with the first and second bar codes on an internet server;
(d) scanning the first bar code on the object with a digital scanner device;
(e) accessing and utilizing the content on the server associated with the first bar code;
(f) scanning the second bar code on the object with a digital scanner device; and
(g) accessing and utilizing the content on the server associated with the second bar code.

2. A method according to claim 1, and including the steps of:
(a) updating/altering the content on the server associated with at least one of the first and second bar codes; and
(b) scanning the updated/altered content on the server with the digital scanner device.

3. A method according to claim 2, wherein the method includes updating/altering the content on the server associated with both the first and second bar codes.

4. A method according to claim 1, wherein the step of preparing the object comprises creating a sticker or label.

5. A method according to claim 1, wherein the scannable digital code is a QR code.

6. A method according to claim 1, wherein the scannable digital code is an image of a physical object.

7. A method according to claim 1, and including the step of creating a discrete passcode for being associated with the predetermined address of the server.

8. A method according to claim 1, and including the step of deleting the selected information from the server after it is downloaded.

9. A product for permitting access to digital content stored on a server, comprising an object having a surface on which is placed a first bar code and a second bar code, the first and second bar codes having distinct URLs for accessing distinct content on the sever that is interrelated with the first and second bar codes.

10. A product according to claim 9, wherein the bar code is a QR code.

11. A product according to claim 9, wherein the content is selected from the group consisting of audio content, video content, audio/video content, text and still images.

12. A product according to claim 9, wherein the first bar code contains content that provides a learning experience to the viewer and the second bar code provides content enabling the user to utilize the content learned by accessing the content associated with the first bar code.

13. A method for providing ready access to information via the internet, comprising the steps of:
(a) assigning two or more users the same bar code;
(b) a transmitting user scanning the bar code with a digital device that displays a digital recording application;
(c) recording content into a recording application of the digital device;
(d) transmitting the recorded content to a server associated with the bar code and storing the recorded content;
(e) transmitting a message to one or more recipients that recorded content has been transmitted for receipt;
(f) scanning by a digital device of the one or more recipients a bar code linked to the same server; and
(g) transmitting the recorded content to the digital device of the one or more recipients for use.

14. A method according to claim 13, and including the step of erasing the recorded content after use by the one or more recipients.

15. A method according to claim 13, and including the step of storing a plurality of transmitted messages wherein item of recorded content is linked to a previous recording and stored.

16. A method according to claim 13, and including the step of electronically providing to the one or more recipients the bar code by which the recorded content is accessed.

17. A method according to claim 13, wherein the transmitting user and the one or more recipients each also act as both the transmitting user and recipient whereby two-way communication is accomplished via the internet.

18. A method according to claim 13, and including the step of deleting the transmitted recorded content after a predetermined time.

19. A method according to claim 13, and including the step of deleting the transmitted recorded content after a predetermined number of instances of use by the one or more recipients.

20. A method according to claim 13, and including the step of electronically providing to the one or more recipients the bar code by which the recorded content is accessed and wherein the transmitting user and the one or more recipients each also act as both the transmitting user and recipient whereby two-way communication is accomplished via the internet.
